(19) United States
(12) Patent Application Publication
(10) Pub. No.: US 2026/0335911 A1
(43) Pub. Date: Oct. 29, 2026

(54) SPRINKLER STRUCTURE WITH MULTI-STAGE WATER CONTROL

(71) Applicant: AQUALEAN MANUFACTURING ASSOCIATES CO., LTD., Taipei City (TW)

(72) Inventors: Pin-Hsien YU, Taipei City (TW); Kai-Yuan CHEN, Taipei City (TW)

(21) Appl. No.: 19/733,343

(22) Filed: Jul. 7, 2026

Related U.S. Application Data
(63) Continuation-in-part of application No. 18/590,330, filed on Feb. 28, 2024.

(51) Int. Cl. B05B 3/04; B05B 12/00

(52) U.S. Cl. CPC B05B 3/0438; B05B 12/002

(57) ABSTRACT

A sprinkler structure with multi-stage water control, comprising a base having an inlet; an oscillation controller disposed at the inlet for generating reciprocating oscillations using water flow; a water spray pipe connected at one end to and driven by the oscillation controller and having multiple nozzles, the water spray assembly including head and tail ends that define a full-length section therebetween; a plurality of segmented water supply chambers arranged along the extending direction of the water spray assembly and distributed throughout the full-length section, each having a water supply port communicating with multiple adjacent nozzles and forming a respective guide track in an orthogonal configuration; and multiple segmented switch controls individually mounted on the guide track of each segmented water supply chamber, each including a button, water seal, and a water-flowing section forming a water-spraying state when in an open position and a water-closing state when in a closed position.

### CROSS-REFERENCE TO RELATED APPLICATIONS

The present application is a continuation-in-part of U.S. Patent Application No. 18/590,330, filed on Feb. 28, 2024.

### FIELD OF THE INVENTION

The present invention relates generally to sprinklers and, more particularly, to an innovative sprinkler structure with multi-stage water control.

### BACKGROUND OF THE INVENTION

Conventional sprinklers commonly include a water spray assembly provided with a plurality of nozzles. The water spray assembly is typically operatively associated with an oscillation controller such that, when pressurized water is introduced into the sprinkler, the oscillation controller utilizes the water flow to generate a reciprocating oscillating motion, thereby enabling the water streams discharged from the nozzles to be sprayed at varying angles.

In order to accommodate diverse operational requirements, some conventional sprinkler designs further provide a control switch at each nozzle so as to individually control the corresponding water discharge mode with greater precision. However, practical implementation of such conventional sprinkler structures has revealed several shortcomings. For example, each control switch must be configured with a corresponding water-sealing arrangement, thereby introducing a potential risk of water leakage. Consequently, when an excessive number of control switches are incorporated, the overall service life of the sprinkler is often adversely affected due to low switch utilization rates and leakage-related deterioration. Furthermore, in order to reserve sufficient installation space for the control switches, the spacing between adjacent nozzles must generally be increased, thereby reducing nozzle distribution density and negatively affecting spraying performance. Accordingly, the foregoing issues constitute significant technical challenges that warrant further attention and improvement within the relevant industry.

### SUMMARY OF THE INVENTION

The primary objective of the present invention is to provide a sprinkler structure with multi-stage water control. More particularly, the present invention is directed to solving the technical problem of developing a sprinkler structure having improved practicality and operational performance.

To achieve the foregoing objective, the present invention provides a sprinkler comprising: a base having an inlet configured to receive a water flow; an oscillation controller disposed at the inlet and configured to generate a reciprocating oscillating motion by utilizing the water flow; a water spray assembly extending along an X-axis and defining a Y-axis orthogonal to the X-axis, the water spray assembly having one end operably connected to the oscillation controller and being provided with a plurality of nozzles arranged at intervals along an extending direction thereof, the water spray assembly including a head end and a tail end that define a full-length section therebetween; and a plurality of segmented water supply chambers arranged at intervals along the extending direction of the water spray assembly and distributed throughout the full-length section, each segmented water supply chamber having a water supply port in fluid communication with a plurality of adjacent nozzles, each segmented water supply chamber further defining a guide track extending along the Y-axis.

A plurality of segmented switch controls are respectively disposed within the guide tracks of the segmented water supply chambers, each segmented switch control comprising: a slider; a button; a water seal; a water-flowing section; and two sealing rings; wherein the water seal and the water-flowing section are disposed on the slider in an adjacent arrangement along the Y-axis, and the two sealing rings are mounted around the button; wherein each segmented switch control is movable between an open position and a closed position, such that the water-flowing section is aligned with the water supply port when the segmented switch control is positioned at the open position, and the water seal is aligned with the water supply port when the segmented switch control is positioned at the closed position; wherein the plurality of segmented switch controls are distributed throughout the full-length section, and a number of the segmented switch controls corresponds to a number of the segmented water supply chambers; wherein the button has an elongated profile defining a major side and a minor side, a length of the major side being greater than twice a length of the minor side; and wherein the button has a double-ended configuration relative to the slider and includes a first end button and a second end button spaced apart from each other along the Y-axis, an outer diameter of each of the first end button and the second end button being greater than an outer diameter of the slider so as to define two retaining flanges, the guide track being provided with two retaining shoulders configured to abut against the retaining flanges to retain movement of the button along the Y-axis, the first end button being integrally formed with the slider, and the second end button being coupled to the slider through a latching unit.

The principal effects and advantages of the present invention include:
(1) providing a full-length segmented multi-stage water control function, thereby rendering water flow control more flexible and comprehensive;
(2) providing the button with an elongated profile, thereby affording a user a larger contact area for finger operation and significantly improving operational convenience; and
(3) providing the first end button integrally connected with the slider while the second end button is assembled to the slider through the latching unit, thereby substantially improving assembly convenience and reducing component complexity.

Another objective of the present invention is achieved by providing the water spray assembly with an inner body and an outer sleeve, wherein the inner body and the outer sleeve are assembled together through axial insertion along the X-axis. The nozzles are formed on the outer sleeve, while the segmented water supply chambers are formed on the inner body. One end of the outer sleeve defines an insertion opening configured to receive the inner body. Corresponding portions of the inner body and the outer sleeve are further provided with a male-female snap-fit unit configured for sliding engagement along the X-axis, such that the axially inserted assembly state between the inner body and the outer sleeve is securely retained. By virtue of this additional technical feature, the water spray assembly exhibits enhanced structural integrity and improved assembly convenience.

### BRIEF DESCRIPTION OF DRAWINGS

FIG. 1 is an assembled perspective view of a preferred embodiment of the present invention.

FIG. 2 is a partially exploded perspective view of the preferred embodiment.

FIG. 3 is an enlarged partial view of FIG. 2.

FIG. 4 is a front view of the water spray assembly according to the preferred embodiment.

FIG. 5 is a sectional view taken along line 5-5 of FIG. 4.

FIG. 6 is a schematic view illustrating profile proportions of a button according to the present invention.

FIG. 7 is a sectional view taken along line 7-7 of FIG. 5.

FIG. 8 is a sectional view illustrating the button in an open position.

FIG. 9 is a sectional view illustrating the button in a closed position.

FIG. 10 is a schematic view illustrating an embodiment of segmented multi-stage water control according to the present invention.

FIG. 11 is a schematic view corresponding to FIG. 10 and illustrating open and closed states of segmented switch controls.

FIG. 12 is an enlarged view of the portion designated by reference numeral 12 in FIG. 8.

FIG. 13 is a sectional view of a flared flow expansion section according to the present invention.

### DETAILED DESCRIPTION OF THE INVENTION

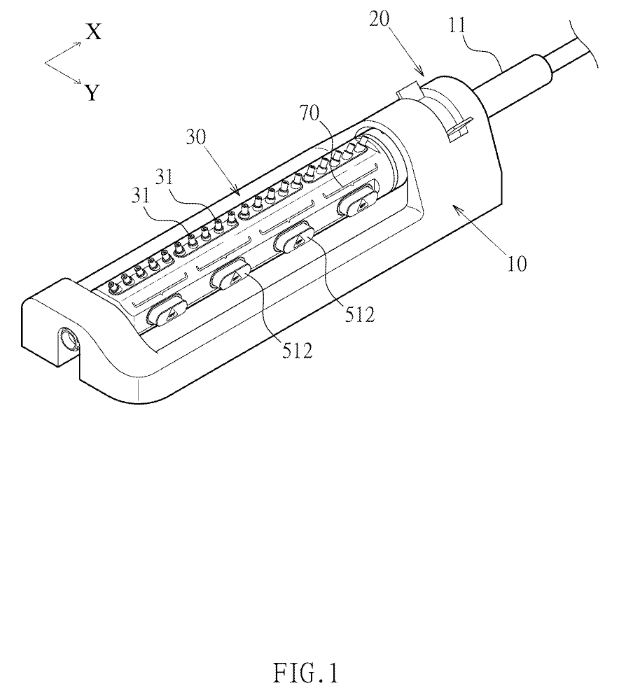

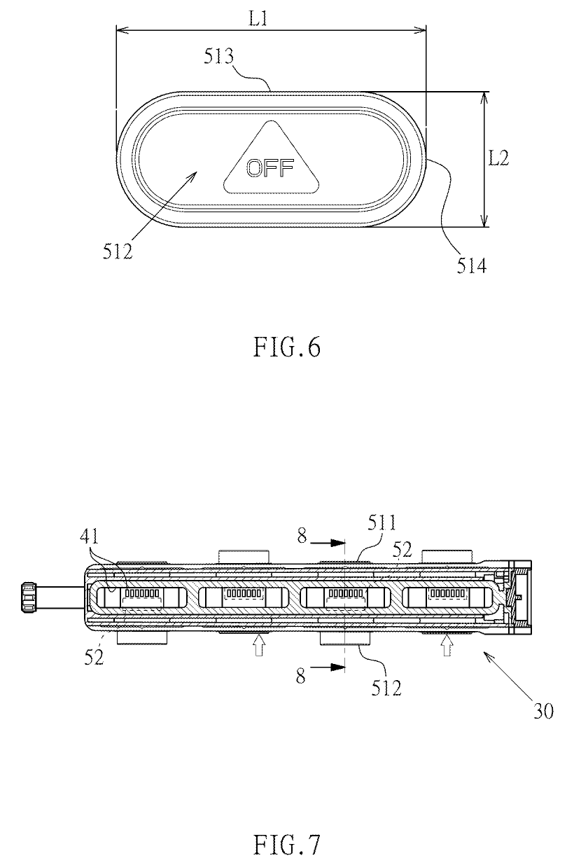

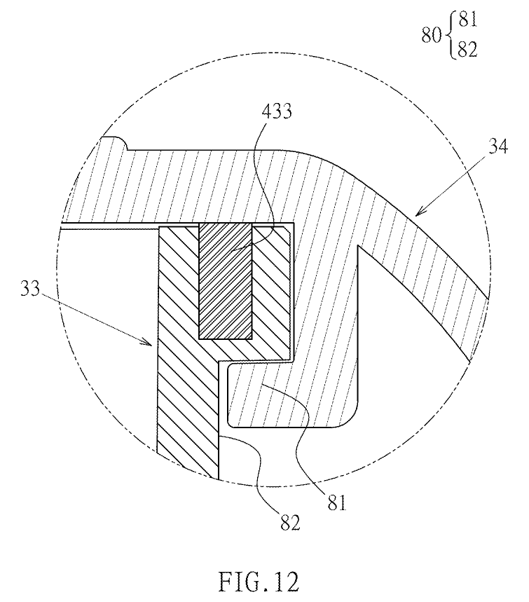

Referring to FIGS. 1 through 13, a preferred embodiment of a sprinkler structure with multi-stage water control according to the present invention is illustrated. It should be understood that the embodiment disclosed herein is provided solely for purposes of illustration and explanation and should not be construed as limiting the scope of the present invention.

The sprinkler structure comprises a base 10 having an inlet 11 configured to introduce a water flow. An oscillation controller 20 is disposed at the inlet 11, wherein the oscillation controller 20 is configured to generate a reciprocating oscillating motion by utilizing the water flow. A water spray assembly 30 extends along an X-axis and defining a Y-axis orthogonal to the X-axis, wherein the water spray assembly 30 has one end operably connected to and driven by the oscillation controller 20, the water spray assembly 30 being provided with a plurality of nozzles 31 spaced apart along an extending direction thereof, the water spray assembly 30 further including a head end 301 and a tail end 302 that collectively define a full-length section 303 extending therebetween.

A plurality of segmented water supply chambers 40 are arranged at intervals along the extending direction of the water spray assembly 30 and distributed throughout the full-length section 303 of the water spray assembly 30, each segmented water supply chamber 40 having a water supply port 41 in fluid communication with a plurality of adjacent nozzles 31, each segmented water supply chamber 40 further correspondingly defining a guide track 42 arranged in an orthogonal relationship relative to the extending direction of the water spray assembly 30, wherein the guide track 42 extends along the Y-axis.

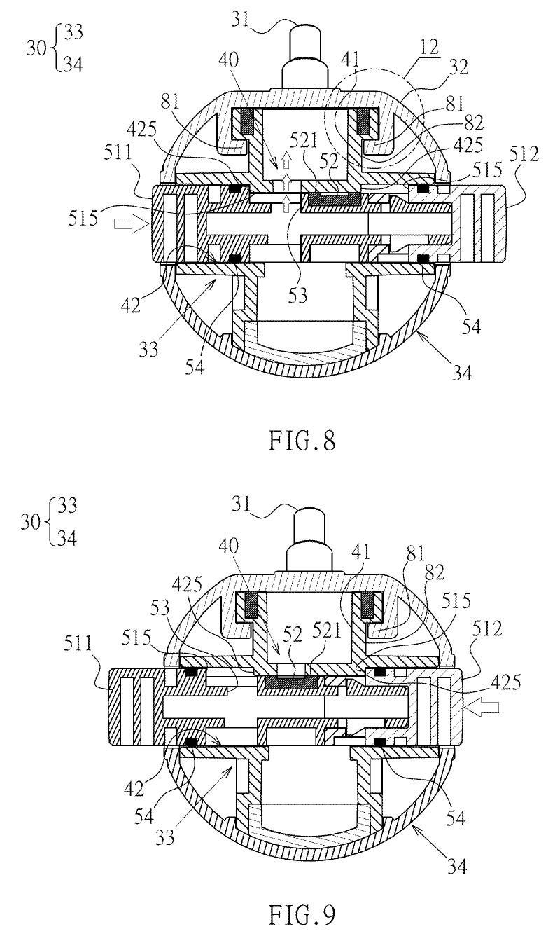

A plurality of segmented switch controls 50 are respectively disposed within the guide tracks 42 of the segmented water supply chambers 40, each segmented switch control 50 including a slider 505, a button 51, a water seal 52, a water-flowing section 53, and two sealing rings 54, wherein the water seal 52 and the water-flowing section 53 are formed on the slider 505 in an adjacent arrangement along the Y-axis, the sealing rings 54 being mounted around the button 51, and each segmented switch control 50 being selectively movable between an open position and a closed position. When the segmented switch control 50 is positioned at the open position, as shown in FIG. 8, the water-flowing section 53 is aligned with the water supply port 41 to establish a water-discharging state. Conversely, when the segmented switch control 50 is positioned at the closed position, as shown in FIG. 9, the water seal 52 is aligned with the water supply port 41 to establish a water-blocking state. Accordingly, full-length segmented multi-stage water control functionality is achieved.

Furthermore, the segmented switch controls 50 are arranged throughout the full-length section 303 of the water spray assembly 30, and the number of the segmented switch controls 50 corresponds to the number of the segmented water supply chambers 40. In addition, each button 51 has an elongated profile defining a major side 513 and a minor side 514, wherein a length L1 of the major side 513 is greater than twice a length L2 of the minor side 514.

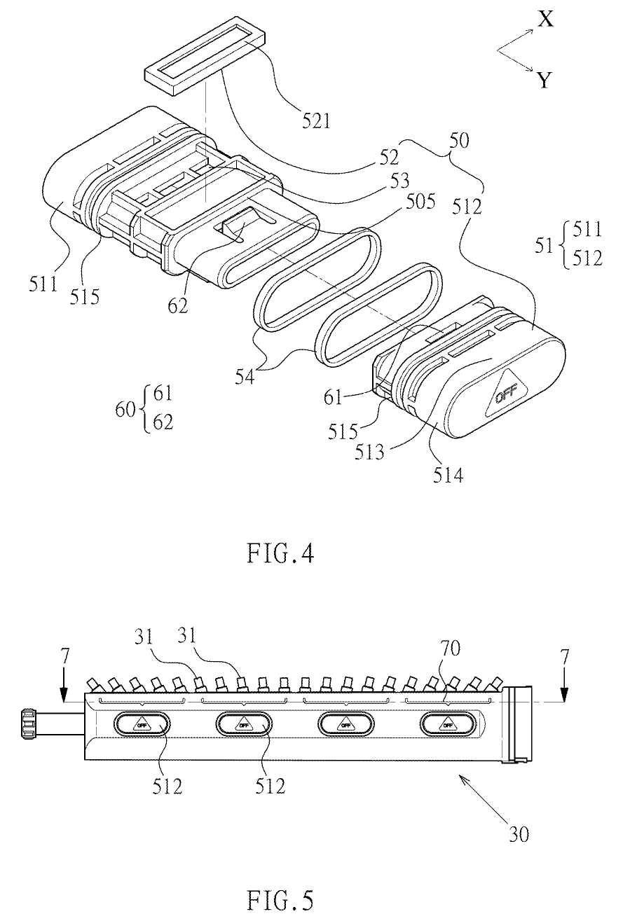

Furthermore, each button 51 has a double-ended configuration relative to the slider 505 and includes a first end button 511 and a second end button 512 spaced apart from each other along the Y-axis. An outer diameter of each of the first end button 511 and the second end button 512 is greater than an outer diameter of the slider 505, thereby defining two retaining flanges 515. Correspondingly, the guide track 42 is provided with two retaining shoulders 425 configured to abut against the retaining flanges 515, thereby retaining an operating stroke of the button 51 along the Y-axis. When a user presses the first end button 511, the segmented switch control 50 is moved to the open position, as shown in FIG. 8. Conversely, when the user presses the second end button 512, the segmented switch control 50 is moved to the closed position, as shown in FIG. 9. The first end button 511 is integrally formed with the slider 505, whereas the second end button 512 is assembled and positioned relative to the slider 505 through a latching unit 60, as shown in FIG. 4.

As shown in FIG. 4, in the present embodiment, the latching unit 60 includes a catch slot 61 formed in the major side 513 of the second end button 512 and a latch hook 62 formed on a corresponding portion of the slider 505.

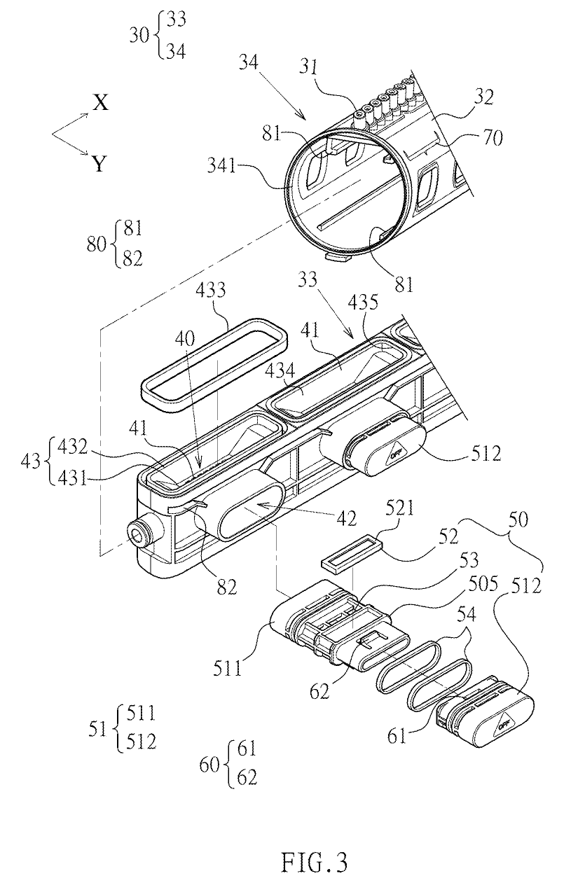

As shown in FIG. 3, in the present embodiment, a finish cover 32 is provided on the water spray assembly 30 and is further formed with a plurality of segmented indicator markings 70 corresponding to respective positions of the buttons 51, thereby facilitating identification by a user of the ranges of the nozzles 31 controlled by the respective buttons 51.

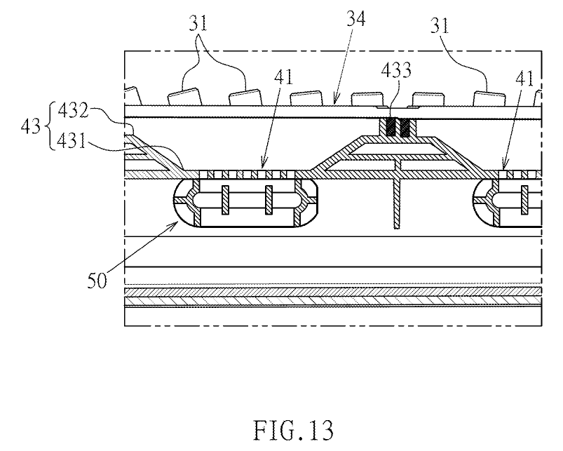

Furthermore, a flow-passage cross-sectional area of the water supply port 41 of each segmented water supply chamber 40 is greater than a combined flow-passage cross-sectional area of the nozzles 31 in fluid communication therewith. In addition, a flared flow expansion section 43 is formed at the water supply port 41, as shown in FIG. 13. The flared flow expansion section 43 includes a small-diameter end 431 and an enlarged-diameter end 432. The small-diameter end 431 communicates with the water supply port 41, and a sealing gasket 433 is fitted within the enlarged-diameter end 432. Furthermore, the flared flow expansion section 43 has an elongated profile defining a major edge 434 and a minor edge 435, wherein a length of the major edge 434 is greater than twice a length of the minor edge 435. By virtue of the foregoing structural configuration, the flared flow expansion section 43 is capable of further increasing the water flow rate through the water supply port 41, thereby enhancing the spraying performance of the sprinkler.

As shown in FIG. 4, in the present embodiment, the water seal 52 is further provided with a raised ridge 521. The raised ridge 521 is aligned with and sealingly engages a peripheral region of the water supply port 41 so as to establish a water-blocking state, as shown in FIG. 9.

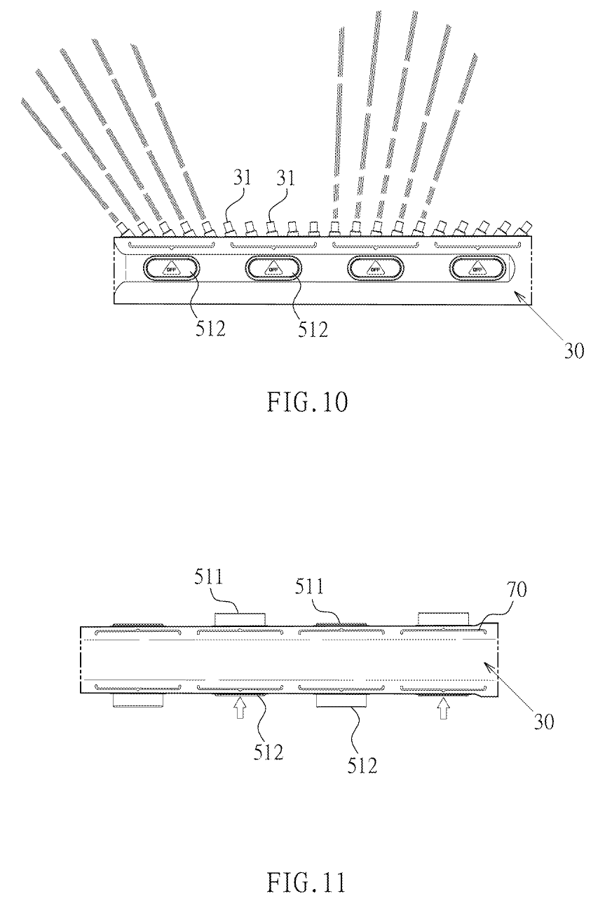

By virtue of the foregoing structural configuration and technical features, the sprinkler structure with multi-stage water control according to the present invention achieves a unique operational arrangement in which each segmented water supply chamber 40 has the water supply port 41 in fluid communication with the plurality of adjacent nozzles 31. Accordingly, the plurality of adjacent nozzles 31 associated with each segmented water supply chamber 40 collectively define an independently controllable water discharge zone. Each water discharge zone may be selectively switched between a water-supplying state and a water-blocking state through the corresponding segmented switch control 50. In practical use, as illustrated in FIGS. 10 and 11, a user may selectively actuate each segmented switch control 50 to an open position or a closed position as desired. Consequently, when the water spray assembly 30 is operated to discharge water, the nozzles 31 of each water discharge zone may selectively spray or cease spraying water according to the switching state of the corresponding segmented switch control 50, thereby achieving the intended functionality and advantages of segmented multi-stage water control. As used herein, the term "multi-stage water control" encompasses various selectable discharge patterns, including full-length discharge, central-zone discharge, end-zone discharge, and other segmented discharge combinations, thereby satisfying diverse user requirements.

Accordingly, the technical features of the present invention provide the following advantages:

First, a full-length segmented multi-stage water control function is achieved, thereby rendering water flow control more flexible and comprehensive. In contrast, conventional sprinkler structures typically provide water flow adjustment only at head-end regions and tail-end regions of a water spray assembly.

Second, each button 51, including the first end button 511 and the second end button 512, has an elongated profile that provides an enlarged contact area for a user's finger during actuation, thereby significantly improving operational convenience.

Third, the structural arrangement in which the first end button 511 is integrally formed with the slider 505 while the second end button 512 is assembled to the slider 505 through the latching unit 60 significantly improves assembly convenience, reduces component complexity, and simplifies the overall structure.

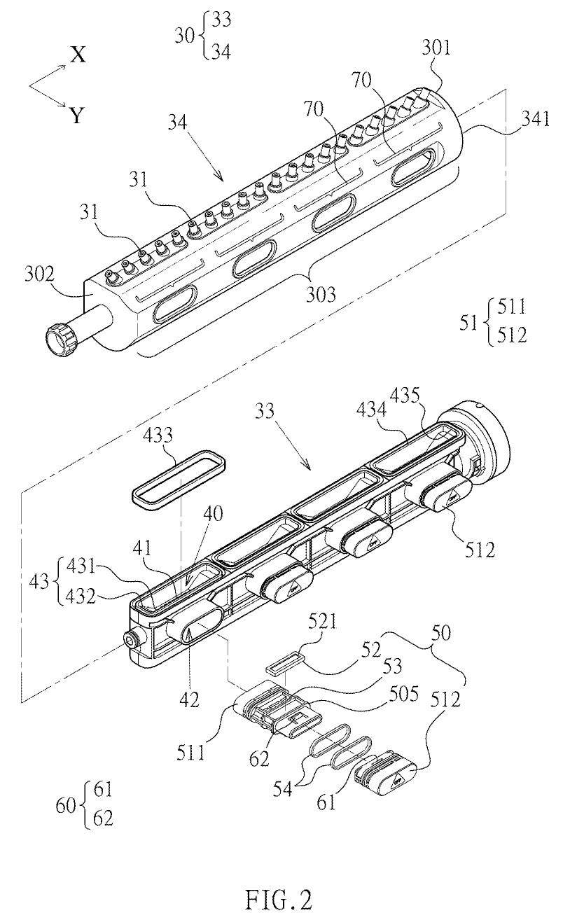

Furthermore, as shown in FIG. 2, the water spray assembly 30 includes an inner body 33 and an outer sleeve 34. The inner body 33 and the outer sleeve 34 are assembled together through axial insertion along the X-axis. The nozzles 31 are formed on the outer sleeve 34, while the segmented water supply chambers 40 are formed on the inner body 33. One end of the outer sleeve 34 defines an insertion opening 341 configured to receive the inner body 33. Corresponding portions of the inner body 33 and the outer sleeve 34 are further provided with a male-female snap-fit unit 80 configured for sliding engagement along the X-axis, thereby securely retaining the inner body 33 and the outer sleeve 34 in an axially assembled state.

In the present embodiment, the male-female snap-fit unit 80 includes a plurality of male retaining ribs 81 formed on the outer sleeve 34 and a plurality of female retaining grooves 82 formed on the inner body 33.

By virtue of the foregoing axial insertion assembly configuration, the water spray assembly 30 can be assembled more conveniently while achieving a more secure structural assembly state. In conventional sprinkler structures, a water spray assembly is commonly formed by joining radial half-shell components through high-frequency heat sealing or fusion bonding processes. However, after prolonged use, the bonded regions are susceptible to cracking or separation due to expansion forces generated by internal water pressure. In contrast, the axial insertion assembly configuration disclosed herein effectively alleviates such drawbacks and provides improved structural reliability and durability.

1. A sprinkler structure with multi-stage water control, comprising:
a base having an inlet configured to receive a water flow;
an oscillation controller disposed at the inlet and configured to generate a reciprocating oscillating motion by utilizing the water flow;
a water spray assembly extending along an X-axis and defining a Y-axis orthogonal to the X-axis, the water spray assembly having one end operably connected to the oscillation controller and being provided with a plurality of nozzles arranged at intervals along an extending direction thereof, the water spray assembly including a head end and a tail end that define a full-length section therebetween;
a plurality of segmented water supply chambers arranged at intervals along the extending direction of the water spray assembly and distributed throughout the full-length section, each segmented water supply chamber having a water supply port in fluid communication with a plurality of adjacent nozzles, each segmented water supply chamber further defining a guide track extending along the Y-axis; and
a plurality of segmented switch controls respectively disposed within the guide tracks of the segmented water supply chambers, each segmented switch control comprising:
a slider;
a button;
a water seal;
a water-flowing section; and
two sealing rings;
wherein the water seal and the water-flowing section are disposed on the slider in an adjacent arrangement along the Y-axis, and the two sealing rings are mounted around the button;
wherein each segmented switch control is movable between an open position and a closed position, such that the water-flowing section is aligned with the water supply port when the segmented switch control is positioned at the open position, and the water seal is aligned with the water supply port when the segmented switch control is positioned at the closed position;
wherein the plurality of segmented switch controls are distributed throughout the full-length section, and a number of the segmented switch controls corresponds to a number of the segmented water supply chambers;
wherein the button has an elongated profile defining a major side and a minor side, a length of the major side being greater than twice a length of the minor side; and
wherein the button has a double-ended configuration relative to the slider and includes a first end button and a second end button spaced apart from each other along the Y-axis, an outer diameter of each of the first end button and the second end button being greater than an outer diameter of the slider so as to define two retaining flanges, the guide track being provided with two retaining shoulders configured to abut against the retaining flanges to retain movement of the button along the Y-axis, the first end button being integrally formed with the slider, and the second end button being coupled to the slider through a latching unit.

2. The sprinkler structure according to claim 1, wherein the latching unit comprises a catch slot formed in the major side of the second end button and a latch hook formed on the slider.

3. The sprinkler structure according to claim 1, further comprising a finish cover disposed on the water spray assembly, wherein the finish cover is provided with a plurality of segmented indicator markings corresponding to positions of the buttons.

4. The sprinkler structure according to claim 1, wherein a flow-passage cross-sectional area of the water supply port of each segmented water supply chamber is greater than a combined flow-passage cross-sectional area of the nozzles in fluid communication therewith, and wherein a flared flow expansion section is formed at the water supply port, the flared flow expansion section including a small-diameter end and an enlarged-diameter end, the small-diameter end being in communication with the water supply port, and a sealing gasket being fitted within the enlarged-diameter end, wherein the flared flow expansion section has an elongated profile defining a major edge and a minor edge, and a length of the major edge is greater than twice a length of the minor edge.

5. The sprinkler structure according to claim 1, wherein the water seal further comprises a raised ridge configured to sealingly engage a peripheral region of the water supply port when the segmented switch control is positioned at the closed position.

6. A sprinkler structure with multi-stage water control, comprising:
a base having an inlet configured to receive a water flow;
an oscillation controller disposed at the inlet and configured to generate a reciprocating oscillating motion by utilizing the water flow;
a water spray assembly extending along an X-axis and defining a Y-axis orthogonal to the X-axis, the water spray assembly having one end operably connected to the oscillation controller and being provided with a plurality of nozzles arranged at intervals along an extending direction thereof, the water spray assembly including a head end and a tail end that define a full-length section therebetween;
a plurality of segmented water supply chambers arranged at intervals along the extending direction of the water spray assembly and distributed throughout the full-length section, each segmented water supply chamber having a water supply port in fluid communication with a plurality of adjacent nozzles, each segmented water supply chamber further defining a guide track extending along the Y-axis;
a plurality of segmented switch controls respectively disposed within the guide tracks of the segmented water supply chambers, each segmented switch control comprising:
a slider;
a button;
a water seal;
a water-flowing section; and
two sealing rings;
wherein the water seal and the water-flowing section are disposed on the slider in an adjacent arrangement along the Y-axis, the two sealing rings being mounted around the button, each segmented switch control being movable between an open position and a closed position such that the water-flowing section is aligned with the water supply port when the segmented switch control is positioned at the open position and the water seal is aligned with the water supply port when the segmented switch control is positioned at the closed position;
wherein the plurality of segmented switch controls are distributed throughout the full-length section, and a number of the segmented switch controls corresponds to a number of the segmented water supply chambers;
wherein the button has an elongated profile defining a major side and a minor side, a length of the major side being greater than twice a length of the minor side;
wherein the button has a double-ended configuration relative to the slider and includes a first end button and a second end button spaced apart from each other along the Y-axis, an outer diameter of each of the first end button and the second end button being greater than an outer diameter of the slider so as to define two retaining flanges, the guide track being provided with two retaining shoulders configured to abut against the retaining flanges to retain movement of the button along the Y-axis, the first end button being integrally formed with the slider, and the second end button being coupled to the slider through a latching unit; and
wherein the water spray assembly comprises an inner body and an outer sleeve assembled together through axial insertion along the X-axis, the plurality of nozzles being formed on the outer sleeve, the plurality of segmented water supply chambers being formed on the inner body, one end of the outer sleeve defining an insertion opening configured to receive the inner body, and corresponding portions of the inner body and the outer sleeve being provided with a male-female snap-fit unit configured for sliding engagement along the X-axis so as to retain the inner body and the outer sleeve in an axially assembled state.

7. The sprinkler structure according to claim 6, wherein the latching unit comprises a catch slot formed in the major side of the second end button and a latch hook formed on the slider.

8. The sprinkler structure according to claim 6, wherein a flow-passage cross-sectional area of the water supply port of each segmented water supply chamber is greater than a combined flow-passage cross-sectional area of the nozzles in fluid communication therewith, and wherein a flared flow expansion section is formed at the water supply port, the flared flow expansion section including a small-diameter end and an enlarged-diameter end, the small-diameter end being in communication with the water supply port, and a sealing gasket being fitted within the enlarged-diameter end, wherein the flared flow expansion section has an elongated profile defining a major edge and a minor edge, and a length of the major edge is greater than twice a length of the minor edge.

9. The sprinkler structure according to claim 6, wherein the water seal further comprises a raised ridge configured to sealingly engage a peripheral region of the water supply port when the segmented switch control is positioned at the closed position.

10. The sprinkler structure according to claim 6, wherein the male-female snap-fit unit comprises a plurality of male retaining ribs formed on the outer sleeve and a plurality of female retaining grooves formed on the inner body
